(19) United States
(12) Patent Application Publication
(10) Pub. No.: US 2020/0016881 A1
(43) Pub. Date: Jan. 16, 2020

(54) Polyurethane Adhesive-Backed Roofing Membranes and Methods of Making the Same

(71) Applicant: ADCO PRODUCTS, LLC, Michigan Center, MI (US)

(72) Inventors: James F. Wood, Jackson, MI (US); John Miller, Hudson, MI (US); Richard Foukes, Shelby Township, MI (US); Kathleen L. Lamb, Jackson, MI (US); Lauren De Vries, Ann Arbor, MI (US); Justin Bates, Clarklake, MI (US)

(21) Appl. No.: 16/485,943

(22) PCT Filed: Feb. 21, 2018
(86) PCT No.: PCT/US2018/018967

§ 371 Date: Aug. 14, 2019

Related U.S. Application Data
(60) Provisional application No. 62/461,420, filed on Feb. 21, 2017.

(51) Int. Cl. B32B 37/12; B32B 37/00; B32B 37/20; B32B 38/18; C09J 5/00; C09J 175/04

(52) U.S. Cl. CPC B32B 37/12; B32B 37/0053; B32B 37/203; B32B 38/1841; C09J 2475/00; C09J 175/04; B32B 2037/1253; B32B 2419/06; C09J 5/00

(57) ABSTRACT

The present disclosure relates to a reverse transfer method of forming a multi-layered roofing membrane composite that includes a release liner, a polyurethane pressure sensitive adhesive layer, and a single-ply roofing membrane. The disclosed methods include coating either a release liner or a single ply membrane with the pressure sensitive adhesive layer to form a composite roll for transport.

### RELATED APPLICATIONS DATA

This application claims priority to U.S. Provisional Application No. 62/461,420 filed on Feb. 21, 2017 and titled Polyurethane Adhesive-Backed Roofing Membranes and Methods of Making the Same.

### FIELD OF INVENTION

The present disclosure relates to a polyurethane adhesive backed membrane for roofing applications. More specifically the disclosure relates to a multi-layered self-adhering roofing membrane formed by laminating a polyurethane pressure sensitive adhesive-release liner composite and a single-ply roofing membrane.

### BACKGROUND

Low slope roofs (≤3-in-12 slope) are generally made weather resistant by the use of single-ply roofing membranes. These membranes are installed over the roof deck using a variety of methods that involves either penetrating metal-based fasteners or non-penetrating adhesive layers to attach the membrane to the roof deck. Membranes that are attached with adhesives are generally done using two types of adhesives—field applied adhesives (i.e. solvent/water based bonding adhesives, reactive adhesives, etc.) or hot melt pressure sensitive adhesives (PSA) pre-applied directly to the membrane creating a self-adhering single-ply membrane. The membranes for these applications may be pre-treated prior to applying the adhesive to the membrane. For example, the membrane may require cleaning or priming with a solvent based product or may need pre-treatment with a specific process such as corona treatment, plasma treatment, etc. The field applied adhesive or membrane pre-treatment approaches involve either the use of undesirable and highly regulated volatile organic solvents (VOC), labor intensive on-site application of an adhesive to the roofing membrane, or use of specialized equipment. These approaches are often restricted, expensive, and time consuming. It is therefore desirable to have a single-ply membrane that is capable of self-adhering to the roof deck with little to no pre-treatment of the single-ply membrane.

### SUMMARY

The present disclosure relates to a process to make a multi-layered roofing membrane composite that includes (i) a release liner, (ii) a pressure sensitive adhesive layer, and (iii) a single-ply roofing membrane. The process for forming a multi-layered roofing membrane composite may be a reverse transfer process that include the steps of providing a release liner, coating a pressure sensitive adhesive on the release liner to form an adhesive-release film composite and wound into a roll, and laminating the adhesive-release film roll and a master single-ply roofing membrane roll by applying pressure to form a finished multi-layered self-adhering roofing membrane.

The process may further comprise a second release liner cast over the adhesive-release film composite.

The present disclosure also relates to a pressure-sensitive adhesive composition for roofing applications. The composition may include a first component comprising a isocyanate prepolymer having approximately 8 to about 10% NCO content, and a second component comprising a polyol, diol, and a catalyst.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is an exploded schematic view of one embodiment of a multi-layer material for use in roofing applications;

FIG. 2 is a schematic representation of one example of a method of making a multi-layer material for use in roofing applications; and

FIG. 3 is a schematic representation of a direct-process for making a multi-layer material for use in roofing applications.

### DETAILED DESCRIPTION

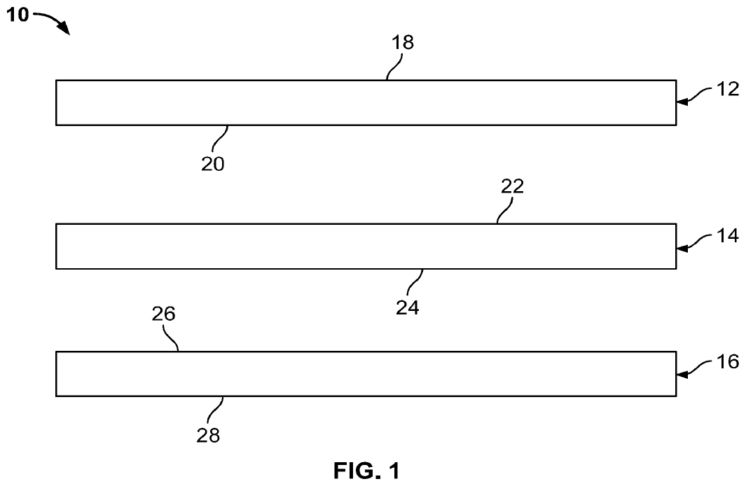

A polyurethane pressure sensitive adhesive-backed roofing membrane includes a multi-layer material that may be wound in to a roll for transport. In one embodiment, as shown in FIG. 1, the multi-layer material 10 may include a single-ply roofing membrane layer 12, a polyurethane (PUR) pressure sensitive adhesive (PSA) layer 14, and a release liner layer 16—each layer having a first side 18, 22, 26 and a second side, 20, 24, 28, respectively. As shown in FIG. 1, the PUR PSA layer 14 may be disposed between the second side 20 of the single-ply roofing membrane layer 12 and the first side 26 of the release liner layer 16.

The multi-layer material 10 may be made by coating the surface of the first side 26 of a release liner layer 16 with a one-part or two-part polyurethane pressure sensitive adhesive. The release liner layer 16 may be a paper or a film coated with a silicone material that imparts a unique property to the liner. The film or paper with the correct silicone coating may further determine the ease of release from the adhesive, differential release for the reverse transfer process, etc. If the release liner 16 is a film then it may be formed from a polyethylene (PE), polypropylene (PP), or polyester (PET). If the release liner 16 is a paper then it may be formed from a PE coated paper or non-PE coated paper. The size of the release liner 16 may match the length and width of a corresponding single-ply roofing membrane layer 12.

While a one-part polyurethane pressure sensitive adhesive may contain a polyol rich pre-polymer partially reacted with a blocked isocyanate, the two-part polyurethane adhesive may generally include a first isocyanate part and a second resin-catalyst part. The first isocyanate part may include any isocyanate terminated prepolymer with approximately 8-10% NCO content such as the commercially available, Rubinate® 9040 from Huntsman, Lupranate® 5020, or Lupranate® 5310 from BASF. The second resin part may be blended until homogeneous, and may include about 0.5 to about 1.0 weight % tertiary amine catalyst (such as the commercially available DABCO® Crystalline Catalyst, Dabco® B-16, Polycat® 17, or Polycat® 15 from Evonik), about 1.0 to about 3.0 weight % low molecular weight diol (such as Dipropylene Glycol, Diethylene Glycol, 1,4-Butane Diol, or Propanediol), about 95 to about 98 weight % of an approximately 6,000 Mw triol polyol (such as the commercially available Pluracol® 220, Pluracol® 1026, Pluracol® 2100 or Pluracol® 380 from BASF, JEFFOL® 31-28 or JEFFOL® 31-35 from Huntsman, Carpol® GP-6015 from Carpenter, Voranol™ 232-027 or Voranol™ 4701 from Dow, or Multranol® 3901 from Covestro), and about 0.1 to about 1.0 weight % of Water. Before application of the two part polyurethane pressure sensitive adhesive on the first side of the release liner 16, the first part is mixed with the second part and blended via static mixer, agitation, or other suitable means. In one embodiment, the adhesive may have an isocyanate index of about 0.60 to about 0.95. In another embodiment, the isocyanate index may be about 0.60 to about 0.80.

The polyurethane adhesive 14 may be applied to the first side 26 of the release liner layer 16 in a predetermined thickness by spray coating, ribbon dispensing with single or multiple dispense heads, slot die head dispensing, or other known method suitable for coating substantially all of the first side 26 of the release liner layer 16. The thickness of the polyurethane adhesive on the first side 26 of the release liner layer may be controlled using calendaring, knife over roll, doctor blade or other suitable method.

It may be appreciated by a skilled person in the art that the thickness of the adhesive may also be controlled by the use of a second liner that can sandwich the adhesive, prepared by mixing the first and second part in a proper ratio, between two release liners. When the sandwiched adhesive is then passed through drum like rollers, a desired thickness of the adhesive may be obtained. Additionally, the spray pattern of the adhesive and the line speed might also allow for the desired adhesive thickness.

In general, the thickness of the polyurethane adhesive coating will be about 0.005″ to about 0.50″.

The polyurethane adhesive forms an elastomeric pressure sensitive adhesive layer 14 and may be cured at room temperature or slightly elevated temperature. In one embodiment, the polyurethane adhesive layer 14 may be formed when the component (i.e., the two-part adhesive) temperature ranges between about 70° F. and about 100° F. and the line temperature ranges between about 70° F. and about 100° F., respectively. The resulting polyurethane adhesive layer 14, when laminated to the single-ply roofing membrane layer 12, may have aggressive tack and adhesion properties and optimized cohesive strength and adequate dead load performance at elevated temperatures (120-180° F.). Dead load is defined as the ability of the adhesive to hold 100 g of weight, over 1 square inch, in a lap shear, for 24 hours at a specified temperature.

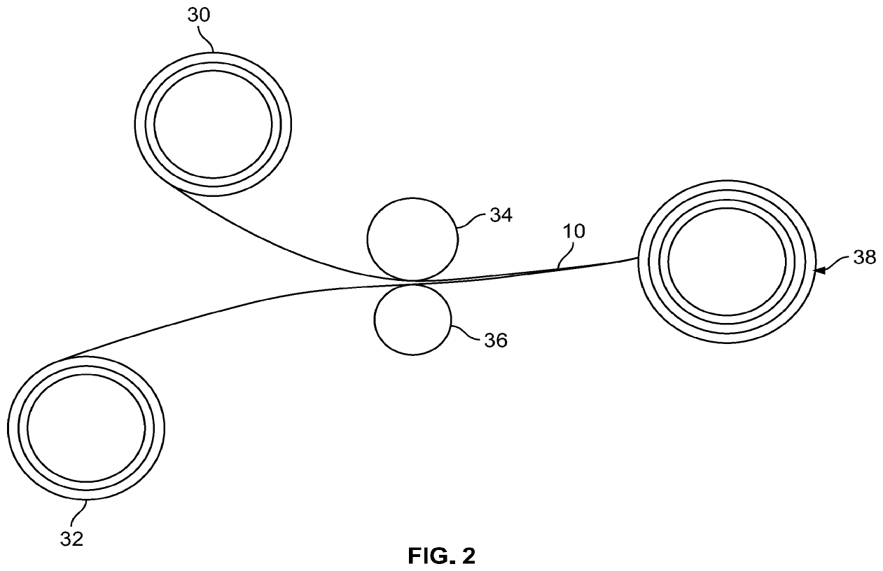

After forming the polyurethane adhesive layer 14 on the first side 26 of the release liner layer 16, the resulting composite sheet may be wound into a first roll 30, as shown in FIG. 2, for further processing or transport. The first roll 30 is wound so that the polyurethane adhesive layer 14 is in contact with the second side 28 of the release liner layer 16. Although only one release liner layer 16 is shown in this embodiment a skilled person in the art would appreciate that more than one release liner layer may be employed in the formation of a composite roll 30. For example, the adhesive 14 may be cast on the first release liner 16, and a second release liner (not shown) may then be laminated to the opposing adhesive 14 surface to form a first liner-adhesive-second liner layers and wound up. When the membrane manufacturer laminates their membrane 12, their second release layer may be removed before mating the adhesive 14 to their membrane 12.

Referring now to FIG. 2, the first roll 30 may be laminated on to a second roll 32 in order to form the multi-layer roofing material or a membrane laminate roll 38. The second roll 32 may generally include the single-ply roofing membrane material layer 12. The membrane material layer 12 may be made of synthetic rubber, such as ethylene propylene diene monomer (EPDM), thermoplastic material, such as a thermoplastic polyolefin (TPO), or a modified bitumen material. In one embodiment, the roofing membrane material layer 12 may have a thickness of about 0.030 to about 0.200 inches and a width of about 2 feet to 50 feet, the width generally matching the width of the release liner layer 16 of the first roll 30.

One method of laminating the adhesive to the single ply roofing membrane material includes a reverse transfer process where the first roll 30 and the second roll 32 are loaded on to spools and then fed through a set of laminating rollers 34 and 36, such as air assisted or weighted rollers. Tension may be applied to each feed line as they enter the rollers in order to help align the adhesive-liner composite sheet onto the membrane material. Upon exiting the rollers 34 and 36, the resulting multi-layer roofing material 10 is then wound into a third roll 38.

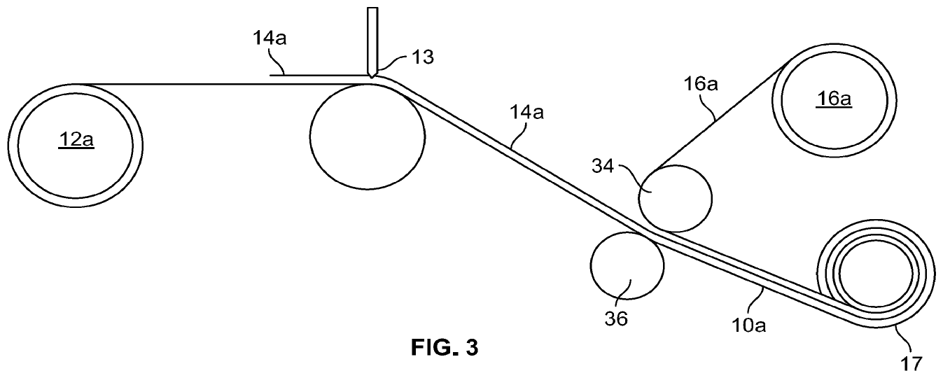

Referring now to FIG. 3, an alternative method for making a multi-layered roofing membrane composite is shown. In this process, the adhesive 14a may be directly coated to the membrane 12a and controlled to a pre-determined thickness by the methods described above (i.e., knife over roll 13). Once coated the adhesive layer 14a may be allowed to cure or partially cure at room temperature or slightly elevated temperatures noted above as it moves down the processing line. After this dwell period, the release liner 16a will be subsequently laminated to the opposing side of the adhesive layer 14a and passed through a set of lamination roller 34a and 36a, such as air assisted or weighted rollers. Upon exiting the rollers 34a and 36a, the resulting multi-layer roofing material 10 is then wound into a roll 17. A person of ordinary skill in the art may also appreciate that the adhesive 14a may be directly coated to the release film 16a, controlled to a pre-determined thickness, allowed to cure or partially cure, with the roofing membrane 12a being laminated to the opposing side of the adhesive layer 14a resulting in the multi-layer roofing material 10a.

In these embodiments, little to no chemical treatment of the single ply membrane material 12 is required. The membrane material need not be washed or prepared with a solvent based primer in order to apply it to the adhesive layer.

In use, the multi-layer roofing material 10 may be unwound from the third roll 38 or 17, the release liner layer 16 or 16a removed, and the adhesive-backed membrane material applied to a roof substrate (not shown), with the adhesive layer 14 or 14a disposed between the roof substrate and the roofing membrane layer 12 or 12a.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1.-15. (canceled)

16. A process for forming a self-adhering roofing membrane composite, the process comprising:
coating a pressure sensitive adhesive layer on a release liner to form an adhesive-release liner composite;
contacting the pressure sensitive adhesive layer to a single ply membrane; and
applying pressure to the adhesive-release liner composite and the single ply membrane to form a self-adhering roofing membrane composite.

17. The process of claim 16, wherein the release liner comprises paper, film, or a combination thereof; and is silicone coated.

18. The process of claim 16, wherein the pressure sensitive adhesive layer comprises a polyurethane adhesive derived from an isocyanate prepolymer component and a resin component.

19. The process of claim 18, wherein the polyurethane adhesive has an isocyanate index of about 0.60 to about 0.95.

20. The process of claim 16, wherein the single-ply membrane comprises ethylene propylene diene monomer, thermoplastic material, modified bitumen material, or a combination thereof.

21. The process of claim 16, wherein the release liner is a film comprising polyethylene, polypropylene, polyester, or a combination thereof.

22. The process of claim 16, wherein the pressure sensitive adhesive layer defines a thickness of about 0.005 inches to about 0.50 inches.

23. The process of claim 16, wherein the pressure sensitive adhesive layer is prepared from a two-part adhesive composition that includes a first component comprising an isocyanate prepolymer having from about 8 to about 10% NCO content, and a second component comprising a polyol and a catalyst.

24. The process of claim 16, wherein the pressure sensitive adhesive layer has adequate dead load performance at a temperature from about 49° C. (about 120° F.) to about 82° C. (about 180° F.).

25. The process of claim 16, further comprising unwinding the adhesive-release liner composite from a first roll, and unwinding the single ply membrane from a second roll before contacting the pressure sensitive adhesive layer to the single ply membrane.

26. The process of claim 16, wherein the singly-ply membrane requires no pre-treatment before contacting the pressure sensitive adhesive layer to the single ply membrane.

27. A pressure sensitive adhesive composition for use in roofing applications, the pressure sensitive adhesive composition comprising:
a first component comprising an isocyanate prepolymer having about 8 to about 10% NCO content; and
a second component comprising a polyol and a catalyst.

28. The pressure sensitive adhesive composition of claim 27, wherein the second component includes from about 0.5 to about 1.0 weight % of tertiary amine catalyst, from about 1.0 to about 3.0 weight % of low molecular weight diol, from about 95 to about 98 weight % of about 6,000 molecular weight triol, and from about 0.1 to about 1.0 weight % water.

29. A process for forming a self-adhering roofing membrane composite, the process comprising:
coating a pressure sensitive adhesive layer on a single-ply membrane to form an self-adhering roofing membrane; and
contacting the pressure sensitive adhesive layer to release liner to form a self-adhering roofing membrane composite.

30. The method of claim 29, wherein the single-ply membrane comprises ethylene propylene diene monomer, thermoplastic material, modified bitumen material, or a combination thereof.

31. The method of claim 29, wherein the release liner comprises paper, film, or a combination thereof; and the release liner is silicone coated.

32. The method of claim 29, wherein the pressure sensitive adhesive layer has adequate dead load performance at a temperature from about 49° C. (about 120° F.) to about 82° C. (about 180° F.).

33. The method of claim 29, wherein the singly-ply membrane requires no pre-treatment before coating the first side of the pressure sensitive adhesive layer to the single-ply membrane.

34. The method of claim 29, wherein the pressure sensitive adhesive layer is a polyurethane adhesive derived from a two part adhesive composition having an isocyanate prepolymer component and a resin component.

35. The method of claim 34, wherein the polyurethane adhesive has an isocyanate index of about 0.60 to about 0.95.
